(19) United States
(12) Patent Application Publication
(10) Pub. No.: US 2025/0219387 A1
(43) Pub. Date: Jul. 3, 2025

(54) HARDLINE CABLE SPLICE BLOCK HAVING A BIASED CONDUCTOR RECEIVING PORTION STRUCTURALLY CONFIGURED TO PROVIDE ENHANCED ELECTRICAL PERFORMANCE

(71) Applicant: PPC BROADBAND, INC., East Syracuse, NY (US)

(72) Inventor: Jordan CAVINESS, Liverpool, NY (US)

(73) Assignee: PPC BROADBAND, INC., East Syracuse, NY (US)

(21) Appl. No.: 19/006,160

(22) Filed: Dec. 30, 2024

Related U.S. Application Data
(60) Provisional application No. 63/616,332, filed on Dec. 29, 2023.

(51) Int. Cl. H02G 15/117; H02G 15/08

(52) U.S. Cl. CPC H02G 15/117; H02G 15/085

(57) ABSTRACT

A hardline cable splice block has a biased conductor receiving portion that provides enhanced electrical performance, including: a body that includes an end port and an additional port that opens in a direction perpendicular to the end port portion; an electrically conductive contact portion supported in and electrically isolated from the body; and electrically conductive receiving portions that are disposed in the end port portion and in the additional port portion and including a biasing portion. A first one of the receiving portions is engaged by a first connector via the end port portion such that the biasing portion of the first one of the receiving portions urges the housing portion of the first one of the receiving portions against the housing portion of a second one of the receiving portions and urges the housing portion of the second one of the receiving portions into engagement with the electrically conductive contact portion, and a second one of the receiving portions is engaged by a second connector via the additional port portion such that the biasing portion of the second one of the receiving portions urges the housing portion of the second one of the receiving portions into contact with the housing portion of the first one of the receiving portions and the electrically conductive contact portion such that the first and second receiving portions provide a signal pathway from an input conductor to an output conductor with reduced electrical noise so as to provide enhanced electrical performance.

### CROSS-REFERENCE TO RELATED APPLICATION

This application claims the benefit of U.S. Provisional Patent Application No. 63/616,332, filed on Dec. 29, 2023, the disclosure of which is hereby incorporated by reference herein in its entirety.

### TECHNICAL FIELD

The present disclosure is directed to a cable adapter and, more particularly, to coaxial cable adapter system with optimized electrical reliability.

### BACKGROUND

While the use of wired cables and connections have provided signals and data transmission to industrial, commercial, and residential sites, the electrical integrity of a wired signal pathway can be suspect. That is, despite physical cabling, such as coaxial, fiber optic, or braided data cables, continuously extending to connect a source and a destination, the use of connectors may be a source of errors, issues, and reliability degradation. For instance, installation in some residential sites, such as high-density apartment complexes, or industrial sites, such as data centers, can involve numerous cable connections that each must provide a consistent and reliable electrical interconnection to utilize the maximum capabilities of the cable string.

With advancements in cabling, interconnections, and signal distribution continually evolving, existing cable arrangements can be reworked, which provides risk for cable connections to physically move, adjust, and twist in manners that alter the electrical integrity and reliability of a signal pathway. Hence, there is a continued goal for electrical connectors to be more secure and reliable over time, particularly during initial installation and any subsequent rework where a cable connection is formed/reformed.

Accordingly, assorted embodiments address such a goal by providing a cable connector system that applies continuous contact force to increase electrical connection integrity and reliability over time.

### SUMMARY

Particular embodiments provide a hardline cable splice block having a biased conductor receiving portion structurally configured to provide enhanced electrical performance, including: a body portion structurally configured to include a through bore portion that opens to end port portions at opposing ends and additional port portions that open in a direction perpendicular to the through bore portion; an electrically conductive contact portion supported in the through bore portion and electrically isolated from the body portion; and an electrically conductive first receiving portion disposed in each of the end port portions and an electrically conductive second receiving portion disposed in each of the additional port portions. The first receiving portion includes a housing portion structurally configured to be disposed in one of the end port portions; a pin receiving portion structurally configured to be slidingly received in the housing portion; a pin gripping portion structurally configured to be coupled with the pin receiving portion; and a biasing portion structurally configured to be disposed between the pin receiving portion and the housing portion and to bias the pin receiving portion and the housing portion away from one another. The second receiving portion includes a housing portion structurally configured to be disposed in one of the additional port portions; a pin receiving portion structurally configured to be slidingly received in the housing portion; a pin gripping portion structurally configured to be coupled with the pin receiving portion; and a biasing portion structurally configured to be disposed between the pin receiving portion and the housing portion and to bias the pin receiving portion and the housing portion away from one another. The housing portion may include a contact portion structurally configured to extend from an end portion of the housing portion in a direction away from the pin receiving portion; the second receiving portion may be structurally configured to receive a conductive pin of a hardline cable connector via one of the additional port portions and the first receiving portion is structurally configured to receive a non-conductive plug via one of the end port portions. The biasing portion of the first receiving portion may be structurally configured to urge the housing portion of the first receiving portion against the contact portion of the housing portion of the second receiving portion and urge the contact portion of the housing portion of the second receiving portion into engagement with the electrically conductive contact portion, and wherein the biasing portion of the second receiving portion may be structurally configured to urge the housing portion of the second receiving portion into contact with the housing portion of the first receiving portion and the electrically conductive contact portion such that the first and second receiving portions provide a signal pathway from an input conductor to an output conductor with reduced electrical noise so as to provide enhanced electrical performance.

According to various embodiments, the first and second receiving portions may be structurally configured to provide a return loss of 20 dB out to 3 GHz.

According to various embodiments, the biasing portion may comprise a helical spring.

According to various embodiments, the second receiving portion may be structurally configured to receive a non-conductive plug via one of the additional port portions and the first receiving portion is structurally configured to receive a conductive pin of a hardline cable connector via one of the end port portions.

Particular embodiments provide a hardline cable splice block having a biased conductor receiving portion structurally configured to provide enhanced electrical performance, including: a body portion structurally configured to include a through bore portion that opens to an end port portion and an additional port portion that opens in a direction perpendicular to the through bore portion; an electrically conductive contact portion supported in the through bore portion and electrically isolated from the body portion; and electrically conductive receiving portions configured to be disposed in the end port portion and in the additional port portion. The receiving portion may include: a housing portion that may be structurally configured to be disposed in the end port portion and the additional port portion; a pin receiving portion that may be structurally configured to be slidingly received in the housing portion and to receive a conductive pin of a hardline cable connector; and a biasing portion that may be structurally configured to be disposed between the pin receiving portion and the housing portion and to bias the pin receiving portion and the housing portion away from one another; and a first one of the receiving portions may be configured to be engaged by a first connector via the end port portion such that the biasing portion of the first one of the receiving portions urges the housing portion of the first one of the receiving portions against the housing portion of a second one of the receiving portions and urges the housing portion of the second one of the receiving portions into engagement with the electrically conductive contact portion, and a second one of the receiving portions may be configured to be engaged by a second connector via the additional port portion such that the biasing portion of the second one of the receiving portions urges the housing portion of the second one of the receiving portions into contact with the housing portion of the first one of the receiving portions and the electrically conductive contact portion such that the first and second receiving portions provide a signal pathway from an input conductor to an output conductor with reduced electrical noise so as to provide enhanced electrical performance.

According to various embodiments, the first and second receiving portions may be structurally configured to provide a return loss of 20 dB out to 3 GHz.

According to various embodiments, the biasing portion may comprise a helical spring.

According to various embodiments, the first one of the receiving portions may be structurally configured to receive a non-conductive plug and the second one of the receiving portions may be structurally configured to receive a conductive pin of a hardline cable connector.

According to various embodiments, the second one of the receiving portions may be structurally configured to receive a non-conductive plug and the first one of the receiving portions may be structurally configured to receive a conductive pin of a hardline cable connector.

According to various embodiments, the first one of the receiving portions may be structurally configured to receive a non-conductive plug and the second one of the receiving portions may be structurally configured to receive a second non-conductive plug.

According to various embodiments, the first one of the receiving portions may be structurally configured to receive a conductive pin of a hardline cable connector and the second one of the receiving portions may be structurally configured to receive a conductive pin of a second hardline cable connector.

Particular embodiments provide a hardline cable splice block having a biased conductor receiving portion structurally configured to provide enhanced electrical performance, including: a body portion structurally configured to include an end port portion and an additional port portion that opens in a direction perpendicular to the end port portion; an electrically conductive contact portion supported in and electrically isolated from the body portion; and electrically conductive receiving portions configured to be disposed in the end port portion and in the additional port portion and including a biasing portion. A first one of the receiving portions may be configured to be engaged by a first connector via the end port portion such that the biasing portion of the first one of the receiving portions urges the housing portion of the first one of the receiving portions against the housing portion of a second one of the receiving portions and urges the housing portion of the second one of the receiving portions into engagement with the electrically conductive contact portion, and a second one of the receiving portions may be configured to be engaged by a second connector via the additional port portion such that the biasing portion of the second one of the receiving portions urges the housing portion of the second one of the receiving portions into contact with the housing portion of the first one of the receiving portions and the electrically conductive contact portion such that the first and second receiving portions provide a signal pathway from an input conductor to an output conductor with reduced electrical noise so as to provide enhanced electrical performance.

According to various embodiments, the first and second receiving portions may be structurally configured to provide a return loss of 20 dB out to 3 GHZ.

According to various embodiments, the biasing portion may comprise a helical spring.

According to various embodiments, the first one of the receiving portions may be structurally configured to receive a non-conductive plug and the second one of the receiving portions may be structurally configured to receive a conductive pin of a hardline cable connector.

According to various embodiments, the second one of the receiving portions may be structurally configured to receive a non-conductive plug and the first one of the receiving portions may be structurally configured to receive a conductive pin of a hardline cable connector.

According to various embodiments, the first one of the receiving portions may be structurally configured to receive a non-conductive plug and the second one of the receiving portions may be structurally configured to receive a second non-conductive plug.

According to various embodiments, the first one of the receiving portions may be structurally configured to receive a conductive pin of a hardline cable connector and the second one of the receiving portions may be structurally configured to receive a conductive pin of a second hardline cable connector.

According to various embodiments, the body portion may be structurally configured to include a through bore portion that opens to the end port portion, and the electrically conductive contact portion may be configured to be supported in the through bore portion.

According to various embodiments, the receiving portion may include: a housing portion that may be structurally configured to be disposed in end port portion and the additional port portion; a pin receiving portion that may be structurally configured to be slidingly received in the housing portion and to receive a conductive pin of a hardline cable connector; and the biasing portion may be structurally configured to be disposed between the pin receiving portion and the housing portion and to bias the pin receiving portion and the housing portion away from one another.

### BRIEF DESCRIPTION OF THE DRAWINGS

Further advantages and features of the present disclosure will become apparent from the following description and the accompanying drawings, to which reference is made.

FIG. 1 is a line representation of portions of a cable environment in which assorted embodiments can be practiced.

FIG. 2 is a line representation of portions of a cable connection assembly that can be employed in the environment of FIG. 1 in various embodiments of this disclosure.

FIG. 3 is a cross-sectional view of portions of an exemplary hardline cable connector that may be employed in the cable environment of FIG. 1 in various embodiments of this disclosure.

FIG. 4 is a cross-sectional view of an exemplary hardline cable connector system configured in accordance with various embodiments of this disclosure.

FIG. 5 is a cross-sectional view of portions of hardline cable connector system capable of being utilized in the environment of FIG. 1 in various embodiments of this disclosure.

FIG. 6 is a cross-sectional view of portions of an exploded hardline cable connector system employed in accordance with various embodiments of this disclosure.

### DETAILED DESCRIPTION

Embodiments of the disclosure provide a connector having a compression portion and an electrical contact that provide a secure electrical contact between a first cable conductor and a second cable conductor to reduce electrical noise.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

In accordance with various embodiments, a hardline cable adapter is configured to provide a secure connection between two separate coaxial cables. A hardline cable adapter has an adapter body, an electrical contact, and a compression portion that collectively operate to connect two cables while providing variable conductor depth within the adapter body. The adapter body has a first threaded portion occupied by a first cable conductor while the electrical contact is positioned within the adapter body. The compression portion is configured to establish an electrical connection through contact of the electrical contact and the first cable conductor. The compression portion employs an electrically conductive spring to engage a conductor sleeve attached to the first cable conductor.

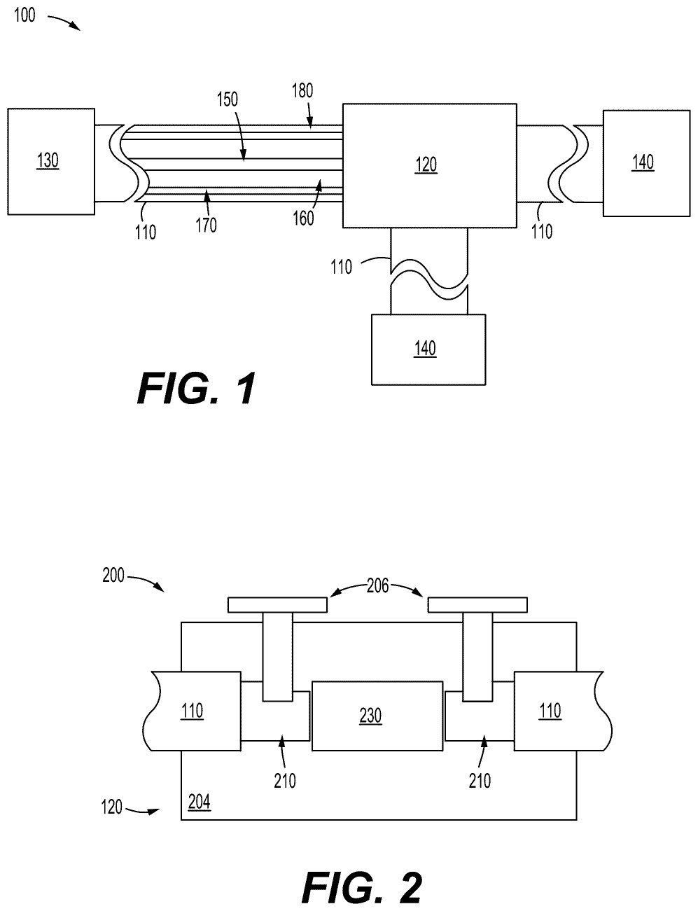

Turning to the drawings, FIG. 1 illustrates portions of a cable environment 100 in which assorted embodiments of a hardline cable adapter system can be practiced. Any number, and type, of cable 110 with signal carrying capabilities can be physically and/or electrically joined by one or more interconnects 120 to provide a continuous signal pathway from a signal source 130 to one or more signal destinations 140.

One or more interconnects 120 can operate to connect the cable 110 to another cable 110 via an interface, an adapter, a fitting, or a connector. Although not required or limiting, the cable 110 can have a signal conductor 150 that is surrounded by an insulating material 160. One or more shielding layers 170 can be positioned between the insulating material 160 and an outer jacket 180. The number of constituent layers and materials can be arranged, in accordance with various embodiments, to provide different physical and electrical capabilities packaged in a selected cable 110 shape and size, such as circularly shaped cables of varying diameters or substantially flat cables having a substantially oval or rectangular cross-sectional shape.

The interconnect 120 may be configured to accommodate any diameter cable 110 with any number, type, and size of constituent materials to provide a predetermined electrical joint. For instance, the interconnect 120 may splice portions of a cable 110 together, provide an intervening electrical contact, or provide a common interface to establish and maintain a secure electrical and physical connection between, previously separate, cables 110. It is contemplated, in various embodiments, that the assorted cables 110 connected via an interconnect 120 have different physical and/or electrical characteristics. As such, some interconnected configurations have cables 110 with different sizes, shapes, constituent materials, or signal transmission capabilities. Other embodiments arrange the interconnect 110 with cables 110 having matching physical dimensions and/or signal-carrying performance capabilities.

FIG. 2 illustrates a line representation of portions of an example cable connection assembly 200 that operates as an interconnect 120 to form a stable signal pathway from at least two separate cables 110. The partial cutout of the interconnect 120 conveys how the separate cables 110 each populate a conductive channel of an adapter body 204. A tightening mechanism 206 physically engages a cable 110 and secures a conductive portion 210 of the cable 110 in place within the body 204 and channel. The tightening mechanism 206 is not limited to a particular assembly or configuration, but may have a threaded engagement that allows for selective engagement of a cable and selective securement of the cable's conductive portion 210, which can include stripped aspects that reveal at least one signal conductor 150.

In some embodiments, the adapter body 204 and constituent conductive channel are configured to physically contact the conductive portions 210 of each cable 110 to form a stable electrical connection and signal pathway through the interconnect 120. However, such arrangement is not required as the adapter body 204 can be configured to position an electrical contact 230 between the conductive portions 210 to form and maintain an electrical connection, and signal pathway, through the interconnect 120. Regardless of the presence of an intervening contact 230, or if the adapter body 204 itself is used to electrically connect the separate cables 110, the interconnect 120 can allow two cables 110 to operate as a reliable signal pathway when installed correctly.

However, the interconnect 120 can pose challenges to cable 110 and/or signal pathway integrity over time. For instance, a tightening mechanism 206 can loosen over time due to inadvertent physical engagement and/or environmental changes, such as temperature or humidity. The tightening mechanism 206 may, alternatively, hinder integrity of a signal pathway through the adapter body 204 if installed incorrectly, such as tightened too much so that aspects of the conductive portion 210 are damaged and/or deformed. While a properly secured cable 110 can provide a secure electrical connection initially, movement of a cable 110 and/or the adapter body 204 can alter the physical contact within the adapter body 204, which can jeopardize the stability and performance of any formed signal pathways.

It is noted that the physical size of the adapter body 204 and tightening mechanisms 206 can be relatively bulky and inflexible, which hinders installation locations and efficiency. That is, a rigid adapter body 204 that surrounds the respective cables 110 may be difficult to manipulate into tight spaces during installation and may not physically fit into areas where cabling is needed, such as residential walls or utility conduits. The inflexibility of the adapter body 204 may further pose risks to established signal pathways as the respective cables 110 move during, and after, installation.

The challenges associated with the structure of an electrical interconnect 120 can be exacerbated when the adapter body 204 does not position the connected cables 110 in the same plane or axis. In other words, altering the orientation of one or more cables 110 relative to other cables 110 connected within an adapter body 204 can pose difficulties to maintaining an electrical connection and signal pathway over time due to the size, inflexibility, and tightening mechanisms 206 of the adapter body 204.

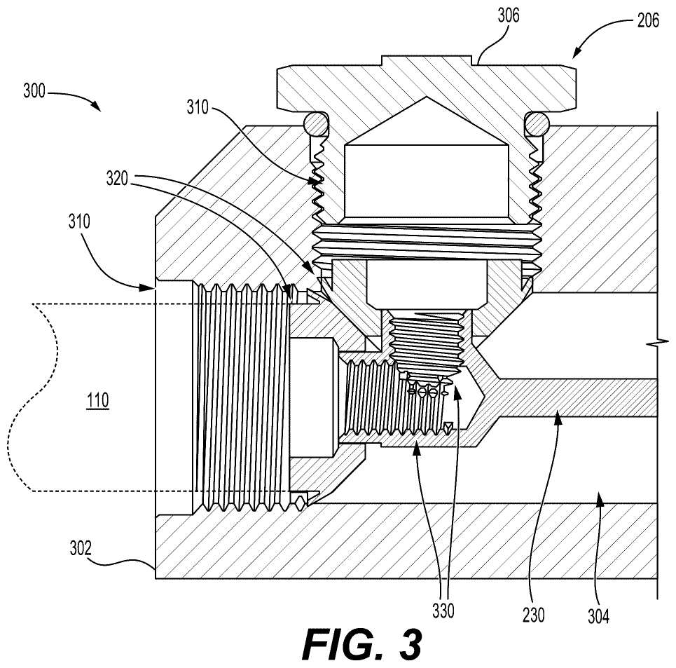

FIG. 3 illustrates portions of a cable connector 300 configured in accordance with various embodiments to provide installation options that can position cables 110 in a variety of orientations, such as along different planes/axes relative to one another. The cross-sectional view of FIG. 3 conveys how an adapter body 302 presents a conductive channel 304 that can provide a secure electrical connection and signal pathway by contacting conductive portions of separate cables, as shown in FIG. 2, with, or without, an intervening electrical contact 230.

The adapter body 302 has a number of threaded portions 310 that can be selectively engaged by a cable 110 or a tightening plug 306. Positioning multiple threaded portions 310 at different locations, and orientations, along the adapter body 302 allows for diverse installation configurations where cables 110 can be oriented up to 90 degrees relative to one another. The non-limiting embodiment shown in FIG. 3 displays how a tightening plug 306 can screw into a threaded portion 310 to physically engage and secure a conductive portion 210 of a cable 110.

By swapping the locations of the tightening plug 306 and cable 110 shown in FIG. 3, the connector 300 can provide an elbow configuration. Yet, such an elbow configuration can pose reliability difficulties as the tightening plug 306 would have less of the adapter body 302 behind the cable 110 to reinforce the physical engagement with the tightening plug 306. Even with a rigid, or semi-rigid, electrical contact 230 present in the channel 304, positioning the tightening plug 306 in the threaded portion 310 oriented 90 degrees from the position shown in FIG. 3 would not have ample construction to provide a secure physical and electrical connection.

With these issues in mind, various embodiments configure each threaded portion 310 with a connection portion 320 that increases the surface area engagement from the respective threaded portions 310 to an electrical contact 230 or conductive portion of a cable 110 present in the body channel 304. Each connection portion 320 has a peripheral retention features that interact with the thread grooves of the respective threaded portion 310 to prevent inadvertent movement of the connection portion 320 outward away from the conductive channel 304. That is, each connection portion 320 has peripheral protrusions that, when deployed, act as a physical stop in response to contacting the grooves of the threaded portion 310.

The retention of the connection portion 320 in a threaded portion 310 allows for efficient use of the threaded portion 310 for a cable 110 or for a tightening plug 306, as shown. The preexisting physical contact between adjacent connection portions 320 operate in combination with the threaded engagement portions that can secure to a portion of a cable 110 to promote secure formation of a signal pathway with the electrical contact 230. It is contemplated, but not required, that a single connection portion 320 is present in a threaded portion 310 to physically and electrically secure a cable to the electrical contact 230.

In some embodiments, the respective connection portions 320 provide a threaded aperture 330, as shown, to allow a set screw (not shown) to extend through the connection portion 320 and physically secure a conductor's position and interaction with the electrical contact 230. That is, a cable's conductor, such as conductor 210 of FIG. 2, can be physically secured to the electrical contact 230 by extending a set screw through a connection portion 320 and into contact with the cable conductor. While use of a set screw in combination with the configuration of the connection portions 320 can increase reliability of the electrical interaction between a cable's conductor and the electrical contact 230, such arrangement can be plagued with installation and environmental challenges associated with applying, and maintaining, proper force onto a conductor over time.

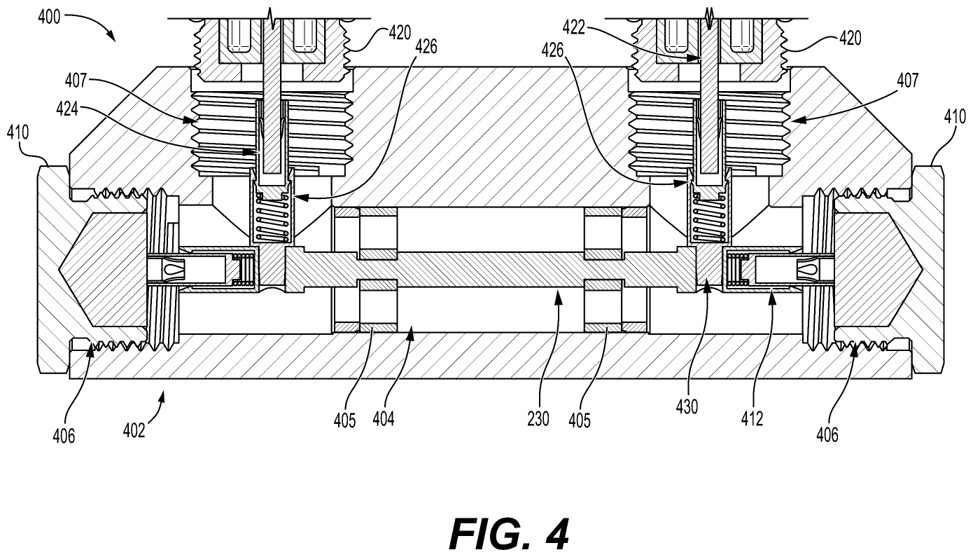

FIGS. 4-6 respectively illustrate aspects of an exemplary receptacle for a hardline cable splice block 400 configured in accordance with various embodiments of this disclosure to be employed in a cable connection, such as the environment 100 of FIG. 1. The splice block 400 has a body portion 402, for example, a unitary body portion, that presents a through bore portion 404 having end port portions 406 that each may include an interior threaded surface portion. An electrically conductive contact portion 230 is held in the through bore portion 404 by non-conductive support portions disposed between the electrically conducting contact portion and the body portion 402, which is also conductive. The threaded port portions 406 can be engaged by connection members 410, 420 depending on a desired configuration of the splice block 400. For example, the connection members 410 comprise plugs or caps and the connection members 420 comprise hardline cable connectors or adapters. The body portion 402 includes two additional port portions 407 that each may include an interior threaded surface portion. The additional port portions 407 of the adapter body 402 are arranged perpendicular to and are open to the through bore portion 404 and are perpendicular to the end port portions 406. The port portions 406, 407 allow for connection members 420 to provide efficient physical and electrical support to connect conductors 422 of the respective cables 110 that input into the adapter 400.

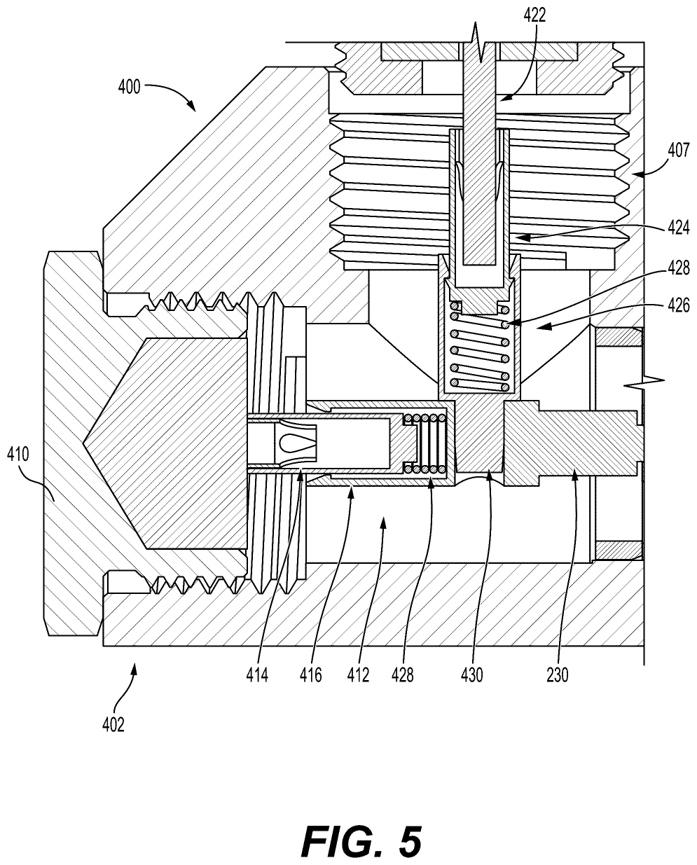

As conveyed in the detailed view of the cable adapter 400 in FIG. 5, each of the end port portions 406 and port portions 407 may be configured to respectively house a receiving portion 412, 430, or receptacle. The receiving portion 412 includes a housing portion 416 structurally configured to slidingly receive a pin receiving portion 414 and a pin gripping portion 432 coupled with the pin receiving portion 414, for example, via a press fit relationship. The pin gripping portion 432 may be configured to flex outward to receive a pin 422, for example, a conductive pin or a center conductor pin of a hardline coaxial cable, and to bias inward to grip the pin. The housing portion 416, the pin receiving portion 414, and the pin gripping portion 432 comprise a conductive material. The pin receiving portion 414 is configured to be biased away from the housing portion 416 by a biasing portion 428, for example, a helical spring, more particularly, a conductive helical spring, such that a portion of the pin receiving portion 414 may be urged away from the housing portion 416 and extend out of an open end portion of the housing portion 416. The pin receiving portion 414 may be configured to define a bearing surface configured to face an internal wall of the housing portion 416 and to be engaged by the biasing portion 428.

Similarly, the receiving portion 430 includes a housing portion 426 structurally configured to slidingly receive a pin receiving portion 424 and a pin gripping portion 432, as described above, coupled with the pin receiving portion 424, for example, via a press fit relationship. The housing portion 426, the pin receiving portion 424, and the pin gripping portion 432 comprise a conductive material. The pin receiving portion 424 is configured to be biased away from the housing portion 426 by a biasing portion 428, for example, a helical spring, more particularly, a conductive helical spring, such that a portion of the pin receiving portion 424 may be urged away from the housing portion 426 and extend out of an open end portion of the housing portion 426. The pin receiving portion 424 may be configured to define a bearing surface configured to face an internal wall of the housing portion 426 and to be engaged by the biasing portion 428.

As illustrated in the exemplary embodiment of FIGS. 4-6, the receiving portion 430 may include a contact portion that extends from an end portion of the housing portion 426 that is opposite the open end portion. The receiving portion 430 is configured to be disposed in the port portion 407 such that the contact portion is structurally configured to contact the housing portion 416 of an adjacent receiving portion 412 and the electrically conductive contact portion 230.

With continued reference to FIGS. 4 and 5, the port portion 406 is configured to threadedly receive a plug portion or cap portion 410 that includes a non-conductive portion 434 configured to contact the receiving portion 412, for example, the pin gripping portion 432 and/or the pin receiving portion 414. The non-conductive portion 434 plug portion or cap portion 410 is configured to electrically isolate the port portion 406 to prevent signal degradation due to the unused port portion 406. For example, the unused ports and corresponding internal components on a conventional four fixed port splice block may form an electrical coupling that act as antennae, which may result in a degraded signal quality. By eliminating the unused ports, the disclosed cable splicing device avoids that concern. For example, when electrically (gated return loss) tested, some conventional splice blocks have shown a return loss of 9 dB out to 3 GHz while the disclosed cable splicing device shows a return loss of 20 dB out to 3 GHz. Such electrical isolation can provide enhanced signal-to-noise ratio for the electrical signals passing from conductor 422 to the electrical contact 230 as well as preventing electrical interference penetrating the body portion 402 or connection member 410 to interrupt, or otherwise jeopardize, the electrical integrity of the contact portion of the housing portion 426. The use of the biasing portion 428 in the housing portion 416 may also ensure consistent force is applied to the contact portion of the housing portion 426 despite movement of the contact portion of the housing portion 426 or overtightening of the connection portion 410 in the bore portion 406.

The port portion 407 is configured to threadedly receive a hardline connector portion or adapter portion 420, which includes a pin 422, for example, a conductive pin or a center conductor pin. The pin gripping portion 432 is structurally configured to slidingly receive the pin 422 and is inwardly biased to grip the pin 422. The pin receiving portion is weaker than the biasing portion 428 such that the biasing portion 428 can remain fully expanded as the pin 422 penetrates the pin gripping portion 432 and the pin receiving portion 424. As the pin 422 is urged further into the pin receiving portion 424, the pin receiving portion 424 urges the biasing portion 428 against the inner end wall of the housing portion 426 and begins to compress the biasing portion 428. As the hardline connector portion or adapter portion 420 is threadedly coupled with the port portion 407, the pin receiving portion 424 further compresses the biasing portion 428 against the inner end wall of the housing portion 426, which in turn urges a bottom wall portion of the housing portion 426 against wall portions of the housing portion 416 of the adjacent receiving portion 412 and the electrically conductive contact portion 230 that face the bottom wall of the housing portion 426. Meanwhile, the threaded connection between the plug portion or cap portion 410 and the port portion 406 urges the pin receiving portion 414 against the biasing member 428, which in turn urges the housing portion 416 of the adjacent receiving portion 412 against the contact portion of the receiving portion 430, which urges the contact portion of the housing portion 420 into contact with the electrically conductive contact portion 230.

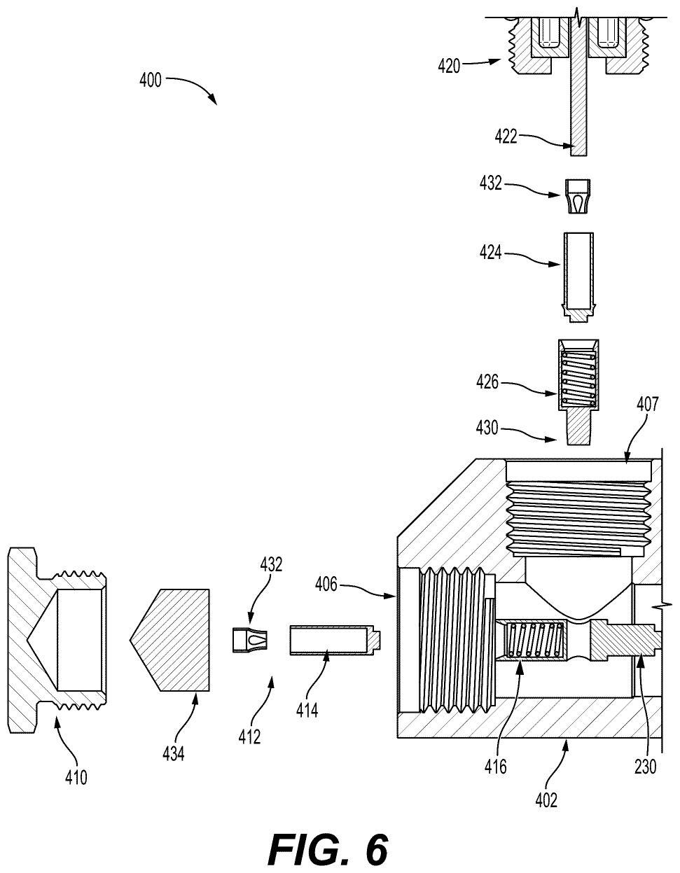

The pin receiving portion 424 is configured to surround portions of the cable conductor 422 and guide the conductor 422 into the housing portion 426 as the connection member 420 rotates to engage deeper aspects of the threaded portion 406. In other words, a male threaded connection member 420 attaches to a cable 110 and rotates to engage further grooves of the female threaded portion 406 to present the cable conductor 422 to allow engagement with the housing portion 426, which is guided by the pin receiving portion 424. As illustrated in the exploded cross-sectional view of FIG. 6, the pin receiving portion 424 can utilize a pin gripping portion 432 to promote electrically conductive fitment of the receiving portion 424 around the conductor 422.

The housing portion 426 contains the biasing portion 428, such as a spring or other force-exerting mechanism, that reacts as a suspension to physical engagement of the pin receiving portion 424 to maintain the position of a contact portion of the receiving portion 430 despite force and/or stress on the cable 110 and conductor 422. That is, the contact portion of the receiving portion 430 comprises an electrically conductive component that maintains secure electrical and physical engagement with a cable conductor 422 via the suspension provided by the interaction of the biasing portion 428 with the pin receiving portion 424.

In contrast to a static arrangement of a cable conductor to an electrical contact 230, as generally illustrated by the connector 300 of FIG. 3, the use of conductive suspensions provided by the biasing portions 428 allow for more efficient and reliable physical contact and electrical connection between the cable conductor 422 and electrical contact 230. That is, the electrically conductive biasing portions 428 ensure a consistent and reliable electrical pathway to the contact portion of the housing portion 426 for variable depths of installation of the connection member 420. In other words, the compressive capability of the biasing portion 428 allows for a secure electrical pathway through the housing portion 426 and to the contact portion of the housing portion 426 for a variety of different connection member 420 installation depths within the bore portion 406. As a result, installation of cable conductor 422 has a greater range of connection member 420 depths within the bore portion 406 than a static conductor connection mechanism, such as the set screw configurations of FIGS. 2 and 3.

Through the use of connection members 410 to apply force on the contact portion of the housing portion 426 attached to conductors 422 of the respective cables 110, physical and electrical engagement of the conductors 422 with the electrical contact 230 can be reliably maintained over time. The concurrent suspensions acting on the respective conductors 422 and the contact portion of the housing portion 426 allow the cable adapter 400 to efficiently be installed and utilized without risk of connection disruption from inadvertent actions, such as overtightening, cable 110 movement, or body portion 402 movement. In other words, the use of dynamic suspensions to apply continuous forces to maintain electrical connections between separate cables 110 provides a manner of flexibility for the adapter body portion 402 and cables 110 that does not jeopardize the integrity of the physical and electrical engagement of the respective cable conductors 422 via the adapter electrical contact 230.

The various embodiments of the conductive suspensions of the cable conductor adapter 400 provide increased installation efficiency along with greater resiliency to connection failure over time. The use of a biasing portion 428 allows for the establishment an electrical connection in a range of different connection member 410 depths within a threaded portion 406. Additionally, the biasing portion 428 allows for mitigation of external forces, such as vibration, temperature changes, and inadvertent physical force from interrupting electrical contact within the adapter 400.

The electrically conductive suspension provided by the biasing portion 428 further provides electrical isolation of an electrical connection from external interference that may be transferred inside the splice block 400 from a connection member 410. Accordingly, the splice block 400 provides optimized electrical connections by employing electrically conductive biasing portions 428 that individually operate to provide variable depth cable installation along with electrical isolation of an internal connection from external electrical interference.

It is noted that, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

It should be appreciated that the housing portion 426 and the pin receiving portion 424 may include complementary engagement features structurally configured to prevent the pin receiving portion 424 from being completely removed from the housing portion 426. Similarly, the housing portion 416 and the pin receiving portion 414 may include complementary engagement features structurally configured to prevent the pin receiving portion 414 from being completely removed from the housing portion 416.

It should be understood that, in some embodiments, the bore portions 406 receive the connection member 420 and the bore portions 407 receive the connection members 410. In other embodiments, one bore portion 406 receives a connection member 410, one bore portion 406 receives a connection member 420, one bore portion 407 receives a connection member 410, and one bore portion 407 receives a connection member 420.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A hardline cable splice block having a biased conductor receiving portion structurally configured to provide enhanced electrical performance, comprising:
a body portion structurally configured to include a through bore portion that opens to end port portions at opposing ends and additional port portions that open in a direction perpendicular to the through bore portion;
an electrically conductive contact portion supported in the through bore portion and electrically isolated from the body portion;
an electrically conductive first receiving portion disposed in each of the end port portions and an electrically conductive second receiving portion disposed in each of the additional port portions;
wherein the first receiving portion includes
a housing portion structurally configured to be disposed in one of the end port portions;
a pin receiving portion structurally configured to be slidingly received in the housing portion;
a pin gripping portion structurally configured to be coupled with the pin receiving portion; and
a biasing portion structurally configured to be disposed between the pin receiving portion and the housing portion and to bias the pin receiving portion and the housing portion away from one another wherein the second receiving portion includes
a housing portion structurally configured to be disposed in one of the additional port portions;
a pin receiving portion structurally configured to be slidingly received in the housing portion;
a pin gripping portion structurally configured to be coupled with the pin receiving portion;
a biasing portion structurally configured to be disposed between the pin receiving portion and the housing portion and to bias the pin receiving portion and the housing portion away from one another; and
wherein the housing portion includes a contact portion structurally configured to extend from an end portion of the housing portion in a direction away from the pin receiving portion;
wherein the second receiving portion is structurally configured to receive a conductive pin of a hardline cable connector via one of the additional port portions and the first receiving portion is structurally configured to receive a non-conductive plug via one of the end port portions; and
wherein the biasing portion of the first receiving portion is structurally configured to urge the housing portion of the first receiving portion against the contact portion of the housing portion of the second receiving portion and urge the contact portion of the housing portion of the second receiving portion into engagement with the electrically conductive contact portion, and wherein the biasing portion of the second receiving portion is structurally configured to urge the housing portion of the second receiving portion into contact with the housing portion of the first receiving portion and the electrically conductive contact portion such that the first and second receiving portions provide a signal pathway from an input conductor to an output conductor with reduced electrical noise so as to provide enhanced electrical performance.

2. The splice block of claim 1, wherein the first and second receiving portions are structurally configured to provide a return loss of 20 dB out to 3 GHZ.

3. The splice block of claim 1, wherein the biasing portion comprises a helical spring.

4. The splice block of claim 1, wherein the second receiving portion is structurally configured to receive a non-conductive plug via one of the additional port portions and the first receiving portion is structurally configured to receive a conductive pin of a hardline cable connector via one of the end port portions.

5. A hardline cable splice block having a biased conductor receiving portion structurally configured to provide enhanced electrical performance, comprising:
a body portion structurally configured to include a through bore portion that opens to an end port portion and an additional port portion that opens in a direction perpendicular to the through bore portion;
an electrically conductive contact portion supported in the through bore portion and electrically isolated from the body portion;
electrically conductive receiving portions configured to be disposed in the end port portion and in the additional port portion;
wherein the receiving portion includes
a housing portion structurally configured to be disposed in the end port portion and the additional port portion;
a pin receiving portion structurally configured to be slidingly received in the housing portion and to receive a conductive pin of a hardline cable connector; and
a biasing portion structurally configured to be disposed between the pin receiving portion and the housing portion and to bias the pin receiving portion and the housing portion away from one another; and
wherein a first one of the receiving portions is configured to be engaged by a first connector via the end port portion such that the biasing portion of the first one of the receiving portions urges the housing portion of the first one of the receiving portions against the housing portion of a second one of the receiving portions and urges the housing portion of the second one of the receiving portions into engagement with the electrically conductive contact portion, and wherein a second one of the receiving portions is configured to be engaged by a second connector via the additional port portion such that the biasing portion of the second one of the receiving portions urges the housing portion of the second one of the receiving portions into contact with the housing portion of the first one of the receiving portions and the electrically conductive contact portion such that the first and second receiving portions provide a signal pathway from an input conductor to an output conductor with reduced electrical noise so as to provide enhanced electrical performance.

6. The splice block of claim 5, wherein the first and second receiving portions are structurally configured to provide a return loss of 20 dB out to 3 GHZ.

7. The splice block of claim 5, wherein the biasing portion comprises a helical spring.

8. The splice block of claim 5, wherein the first one of the receiving portions is structurally configured to receive a non-conductive plug and the second one of the receiving portions is structurally configured to receive a conductive pin of a hardline cable connector.

9. The splice block of claim 5, wherein the second one of the receiving portions is structurally configured to receive a non-conductive plug and the first one of the receiving portions is structurally configured to receive a conductive pin of a hardline cable connector.

10. The splice block of claim 5, wherein the first one of the receiving portions is structurally configured to receive a non-conductive plug and the second one of the receiving portions is structurally configured to receive a second non-conductive plug.

11. The splice block of claim 5, wherein the first one of the receiving portions is structurally configured to receive a conductive pin of a hardline cable connector and the second one of the receiving portions is structurally configured to receive a conductive pin of a second hardline cable connector.

12. A hardline cable splice block having a biased conductor receiving portion structurally configured to provide enhanced electrical performance, comprising:
a body portion structurally configured to include an end port portion and an additional port portion that opens in a direction perpendicular to the end port portion;
an electrically conductive contact portion supported in and electrically isolated from the body portion;
electrically conductive receiving portions configured to be disposed in the end port portion and in the additional port portion and including a biasing portion; and
wherein a first one of the receiving portions is configured to be engaged by a first connector via the end port portion such that the biasing portion of the first one of the receiving portions urges the housing portion of the first one of the receiving portions against the housing portion of a second one of the receiving portions and urges the housing portion of the second one of the receiving portions into engagement with the electrically conductive contact portion, and wherein a second one of the receiving portions is configured to be engaged by a second connector via the additional port portion such that the biasing portion of the second one of the receiving portions urges the housing portion of the second one of the receiving portions into contact with the housing portion of the first one of the receiving portions and the electrically conductive contact portion such that the first and second receiving portions provide a signal pathway from an input conductor to an output conductor with reduced electrical noise so as to provide enhanced electrical performance.

13. The splice block of claim 12, wherein the first and second receiving portions are structurally configured to provide a return loss of 20 dB out to 3 GHz.

14. The splice block of claim 12, wherein the biasing portion comprises a helical spring.

15. The splice block of claim 12, wherein the first one of the receiving portions is structurally configured to receive a non-conductive plug and the second one of the receiving portions is structurally configured to receive a conductive pin of a hardline cable connector.

16. The splice block of claim 12, wherein the second one of the receiving portions is structurally configured to receive a non-conductive plug and the first one of the receiving portions is structurally configured to receive a conductive pin of a hardline cable connector.

17. The splice block of claim 12, wherein the first one of the receiving portions is structurally configured to receive a non-conductive plug and the second one of the receiving portions is structurally configured to receive a second non-conductive plug.

18. The splice block of claim 12, wherein the first one of the receiving portions is structurally configured to receive a conductive pin of a hardline cable connector and the second one of the receiving portions is structurally configured to receive a conductive pin of a second hardline cable connector.

19. The splice block of claim 12, wherein the body portion is structurally configured to include a through bore portion that opens to the end port portion; and
wherein the electrically conductive contact portion is configured to be supported in the through bore portion.

20. The splice block of claim 12, wherein the receiving portion comprising:
a housing portion structurally configured to be disposed in end port portion and the additional port portion;
a pin receiving portion structurally configured to be slidingly received in the housing portion and to receive a conductive pin of a hardline cable connector; and
wherein the biasing portion structurally configured to be disposed between the pin receiving portion and the housing portion and to bias the pin receiving portion and the housing portion away from one another.
